(19) United States
(12) Patent Application Publication
(10) Pub. No.: US 2018/0219757 A1
(43) Pub. Date: Aug. 2, 2018

(54) LINK LAYER PATH LATENCY PROTOCOL TO MONITOR PER-HOP PATH LATENCY

(71) Applicant: Fortinet, Inc., Sunnyvale, CA (US)

(72) Inventors: Kelly A. Wanser, San Francisco, CA (US); Cyrus J. Durgin, Seattle, WA (US)

(73) Assignee: Fortinet, Inc., Sunnyvale, CA (US)

(21) Appl. No.: 15/419,106

(22) Filed: Jan. 30, 2017

(51) Int. Cl. H04L 12/26; H04L 12/24

(52) U.S. Cl. CPC H04L 43/0852; H04L 41/046

(57) ABSTRACT

Methods and systems for implementing a link layer path latency protocol (LLPLP) to monitor per-hop path latency are provided. According to one embodiment, a LLPLP message of a first type, including multiple hop records corresponding to multiple hops in a unique set of hops derived from all possible paths between a start node and an end node within the private network, is sent to a source node specified by a first hop record of the multiple hop records. Receipt of the LLPLP message by a source node specified in one or more hop records causes the source node to send one or more LLPLP messages of the first type to corresponding destination nodes. Receipt of the LLPLP message by a destination node specified in one or more hop records causes the destination node to calculate and return latency measurements for the appropriate hops via LLPLP messages of a second type.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2017, Fortinet, Inc.

### BACKGROUND

### Field

Embodiments of the present invention generally relate network communications. In particular, embodiments of the present invention relate to a link layer path latency protocol (LLPLP) to monitor per-hop path latency.

### Description of the Related Art

A network management system (NMS) is a system used to monitor and administer a network of devices. A network of devices is collection of devices that are interconnected by a data network that allows for the sharing of resources and information. Each of these devices can be a physical or virtual device. In addition, each of these devices may have one or more different services running on that device, where the service is accessible over this network. Furthermore, each of the devices that are visible to the NMS is called a managed node.

While traditional NMSs and tools do an adequate job of facilitating management of individual software and/or hardware components of a network by a network administration, they have limitations, including the lack of a centralized “bird's eye view” of the network as a whole. Additionally, although standard ping and traceroute utilities are able to verify a particular Internet Protocol address exists and is capable of accepting requests and can track the route of packets between two Layer 3 nodes, these and other traditional network tools are unable measure end-to-end path latencies between any two arbitrary points in a network regardless of the protocols or high-level “connectivity” between those points.

### SUMMARY

Methods and systems are described for implementing a link layer path latency protocol (LLPLP) to monitor per-hop path latency. According to one embodiment, a LLPLP message of a first type, including multiple hop records corresponding to multiple hops in a unique set of hops derived from all possible paths between a start node and an end node within the private network, is sent to a source node specified by a first hop record of the multiple hop records. Receipt of the LLPLP message by a source node specified in one or more hop records causes the source node to send one or more LLPLP messages of the first type to corresponding destination nodes. Receipt of the LLPLP message by a destination node specified in one or more hop records causes the destination node to calculate and return latency measurements for the appropriate hops via LLPLP messages of a second type.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a block diagram of a system for implementing a link layer path latency protocol (LLPLP) to monitor per-hop path latency in accordance with an embodiment of the present invention.

FIG. 2 illustrates a LLPLP message according to one embodiment of the present invention.

FIG. 3 illustrates a flow diagram of an example method for implementing a LLPLP to monitor per-hop path latency according to one embodiment of the present invention.

FIG. 4 illustrates a flow diagram of an example method for processing an LLPLP message according to one embodiment of the present invention.

FIG. 5 is a block diagram of exemplary components of an electronic device in which one of the LLPLP actors in a system implementing LLPLP to monitor per-hop path latency may be implemented in accordance with aspects of the present disclosure.

### DETAILED DESCRIPTION

Methods and systems are described for implementing a link layer path latency protocol (LLPLP) to monitor per-hop path latency.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

### Terminology

Brief definitions of terms used throughout this application are given below.

The terms “connected” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

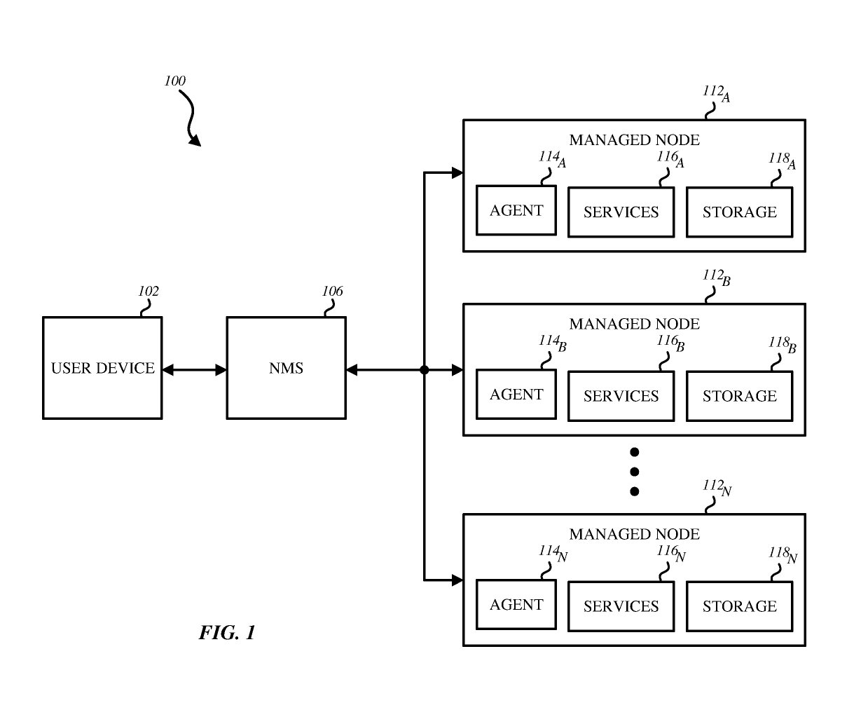

FIG. 1 is a block diagram of a system 100 implementing a link layer path latency protocol (LLPLP) to monitor per-hop path latency in accordance with an embodiment of the present invention. System 100 has a unique benefit over traditional network management systems and tools. It has both a centralized “bird's eye view” of the network as a whole and a distributed fabric of agents able to take action on a specific node. In some embodiments, this powerful combination is leveraged to obtain the measurement of end-to-end path latencies between any two points in the network or system 100, regardless of the protocols or high-level “connectivity” between those points.

Specifically, a Link Layer Path Latency Protocol (LLPLP) may be implemented in system 100 and used to produce high-resolution, fine-grained path latency measurements. The link layer path latency protocol provides a mechanism for performing highly granular path latency calculations between arbitrary endpoints in the network. Unlike the standard ping and traceroute utilities, there is no requirement that endpoints have reachability at layer 3. Any two endpoints that support capture and transmission of arbitrary packets can participate in an LLPLP measurement. LLPLP is simple and distributed. It is simple because it does not require any state (beyond a per-measurement unique identifier) to be shared among actors. It is distributed because many actors of different types pass messages of different types to cooperatively perform a path latency measurement.

LLPLP may require that system clocks across any network being measure be synchronized; the majority of professionally operated environments will rely on network time protocol (NTP) or a similar protocol for this purpose. LLPLP may take advantage of finer grained synchronization mechanisms, e.g., precision time protocol (PTP), when available.

Referring to FIG. 1, the system 100 includes managed nodes 112A-N and a network management system (NMS) 106. In FIG. 1, the NMS 106 is used to control a number of managed nodes 112A-N. In one embodiment, a system administrator interacts with the NMS 106 through a user interface that is running on a device 102.

In one embodiment, each of the managed nodes 112A-N is a device in the system 100 that is visible to the NMS 106. In one embodiment, a managed node can be a network element, a personal computer, mobile device, etc., or any other type of device that can communicate data over a network. In one embodiment, a network element can be a network access element (e.g., switch, router, hub, bridge, gateway, etc., or any type of device that can allow access to a network), a network security device (e.g., firewall, intrusion detection/prevention system, a gateway, a unified threat management device, etc.), or another type of device that processes networked data. In one embodiment, the managed node 112A-N can be a physical or virtual device. In one embodiment, the managed nodes 112A-N are communicatively coupled to each other, the NMS 106, and the device 102 through a network. In one embodiment, each of the managed nodes 112A-N includes an agent 114A-N, one or more services 116A-N, and storage 118A-N. In this embodiment, the agent 114A-N is a module that runs on the corresponding managed node 114A-N and provides an interface to manage that managed node 114A-N and/or the one or more services 116A-N. For example and in one embodiment, a service for the managed node can be a physical component of the managed node (port, link, etc.), or a networked service (switching, routing, security, administrative, computing service, storage, etc.)

In another embodiment, agent 114A-N runs on a device coupled to the corresponding managed node 112A-N. In this embodiment, the agent 114A-N proxies communications (e.g., data, management data, commands, LLPLP messages) between the NMS 106 and the corresponding managed node 112A-N.

In one embodiment, the services 116A-N running the managed nodes 112A-N are processes that provide a functionality to other devices in the network that are communicatively coupled to the managed node 112A-N hosting the service 116A-N. For example and in one embodiment, a service 116A-N can be a communication service (e.g., switching, routing, packet forwarding, traffic shaping, applying quality of service (QoS), remote access, etc.), security service (e.g., firewall, intrusion detection/prevention, malware protection, content filtering, virtual private networking, physical access control, etc.), cloud services (software-as-a-service (SaaS), infrastructure-as-a-service (IaaS), etc.), virtualized services (machines, networking, storage, etc.), business services (e.g., web service, trading service, etc.), and infrastructure services (e.g., environmental control service, power management and monitoring service, etc.). In one embodiment, the NMS 106 can manage these services 116A-N via agent 114A-N associated with that service 116A-N. In one embodiment, the storage 118A-N stores the management data and other data.

### Actors:

An LLPLP actor is any node, element or process participating in an LLPLP measurement. Three basic types of actors in an LLPLP-enabled environment include: (i) initiating actor the service or user requesting the path latency measurement; (ii) component actor a network element within the path being measured; and (iii) reporting actor the service collecting measurement records. Accordingly, in FIG. 1, any one of the managed node 112A-N or the NMS 106 may be an LLPLP actor.

### Messages:

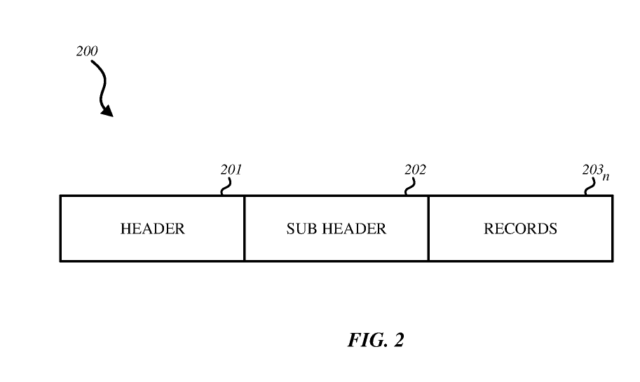

LLPLP actors may communicate LLPLP messages with each other. FIG. 2 illustrates a LLPLP message according to one embodiment of the present invention. As shown in FIG. 2, an LLPLP message 200 may include a header 201 describing the path measurement, a sub-header 202 describing the type of message, and one or more records 203ₙ (n>1). A sub-header indicates whether the included records are: (i) hop records: details concerning a hop to be measured; or (ii) measurement records: the results of a hop measurement.

### Paths and Hops:

According to one embodiment, LLPLP does not perform any path discovery. It is the responsibility of the initiating actor to discover and decompose the path(s) being measured into a series of hops. Each hop specifies a local and remote identifier for each link in the measurement. A hop may be described as {local, remote}; Square brackets ([ ]) may encapsulate a network or a path through the network; and letters may be used to identify a device, and numbers may be used to identify a physical port or other locally unique component. Hops are referred to in sequence, beginning with 1. Each path has at least one hop. These sequence numbers are also referred to as generations.

### Path Decomposition:

For a given set of paths (composed of a set of hops), a unique set of hops is calculated by the initiating actor. This means for any set of paths each hop will be tested equally, even if a single hop appears in multiple paths.

In one embodiment, the path decomposition of a network may be described as follows. An example of a network may be represented as follows:

TABLE 1
Example Representation of a Network

[
{A1, B1},
{A2, B2},
{B4, E1},
{E2, F2},
{E3, F3},
{B3, C3},
{C1, D1},
{C2, D2}
]

The example network yields the following paths from device A to device D:

TABLE 2
Paths from Device A to Device D

```
[
    [{A1, B1}, {B3, C3}, {C1, D1}],
    [{A1, B1}, {B3, C3}, {C2, D2}],
    [{A2, B2}, {B3, C3}, {C1, D2}],
    [{A2, B2}, {B3, C3}, {C2, D2}]
]
```

These paths decompose into the unique set of hops:

TABLE 3
A Unique Set of Hops from Device A to Device D

[
[{A1, B1}, {A2, B2}], # first generation
[{B3, C3} ], # second generation
[{C1, D1}, {C2, D2}] # third generation
]

### Hop Generations

A hop's generation is the integer 1 plus the number of steps away from the first endpoint in the path the hop appears. For example, for a path [{A1, B1}, {B2, C2}, {C1, D1}], the hop {B2, C2} is referred to as a second generation hop, or hop #2.

Because a given hop may appear at a different generation in different paths being tested by a single measurement, a bit-mask is used to indicate the generation(s) of each hop in an LLPLP message.

### LLPLP Messages

Referring back to FIG. 2, an example LLPLP message 200 includes: a header 201, a subheader 202, and one or more records 203ₙ. The following tables are examples of the fields included in the LLPLP messages and the definition of the fields.

TABLE 4
LLPLP header fields

| Field | Definition |
|---|---|
| VERSION | 3-part semantic version number specifying |
| | the version of the protocol |
| | in use by the sender of this message. |
| UUID | Version 4 UUID uniquely identifying |
| | this path measurement. |
| SENT_AT | Timestamp when the LLPLP message was sent. |
| MESSAGE_COUNT | The number of messages to be sent |
| | between each hop endpoint. |

TABLE 5
LLPLP sub-header fields

| Field | Definition |
|---|---|
| RECORD_TYPE | Specifies the type of the included records. |
| RECORD_COUNT | The number of records included in this message. |

TABLE 6
LLPLP hop record fields

| Field | Definition |
|---|---|
| GENERATION_MASK | Bitmask identifying which generation(s) of |
| | the path being measured this hop belongs to. |
| LOCAL_DEVICE | UUID of the device sending this message. |
| LOCAL_INTERFACE | Identifier of the interface from which |
| | this message is sent. |
| REMOTE_DEVICE | UUID of the device receiving this message. |
| REMOTE_INTERFACE | Identifier of the interface on which |
| | this message is received. |
| MESSAGE_NUMBER | Index of the message instance. |

TABLE 7
LLPLP measurement record fields

| Field | Definition |
|---|---|
| GENERATION_MASK | Bitmask identifying which generation(s) of |
| | the path being measured this hop belongs to. |
| LOCAL_DEVICE | UUID of the device sending this message. |
| LOCAL_INTERFACE | Identifier of the interface from which |
| | this message is sent. |
| REMOTE_DEVICE | UUID of the device receiving this message. |
| REMOTE_INTERFACE | Identifier of the interface on which |
| | this message is received. |
| LATENCIES | Array of latencies representing the transmission |
| | time of messages for this hop. |

Various embodiments of the present invention may be described in the form of one or more processes each of which are usually depicted in the form of one or more of a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a procedure, etc.

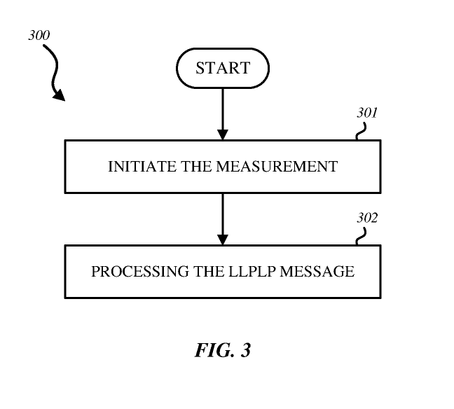

FIG. 3 illustrates a flow diagram of an example method 300 for implementing a LLPLP to monitor per-hop path latency according to one embodiment of the present invention. In order to perform an LLPLP measurement, the method 300 starts by initiating the measurement (Block 301). In one embodiment, to initiate the measurement, the initiating actor must first discover (e.g., by querying the Path Service) the path(s) to be measured. These paths must then be decomposed into the set of hops to be measured individually. Next the initiating actor composes an LLPLP message, setting header and sub header values and appending the appropriate hop records. Header values should indicate the version of LLPLP the initiating actor is using, a randomly generated universally unique identifier (UUID) to identify this measurement, a timestamp for measurement creation time, and a value representing the number of messages to be sent between each component actor. The sub-header should indicate that the message contains the correct number of hop records. The initiating actor then sends the message to the local node in the first hop (typically using a HyperText Transfer Protocol (HTTP)-based mechanism—e.g., the agent command processor—though any mechanism to inject the message onto a network segment the node is attached to should trigger the correct behavior).

At Block 302, the message is then processed. LLPLP is a stateless protocol, so all messages are processed accordingly by the component actor or the reporting actor.

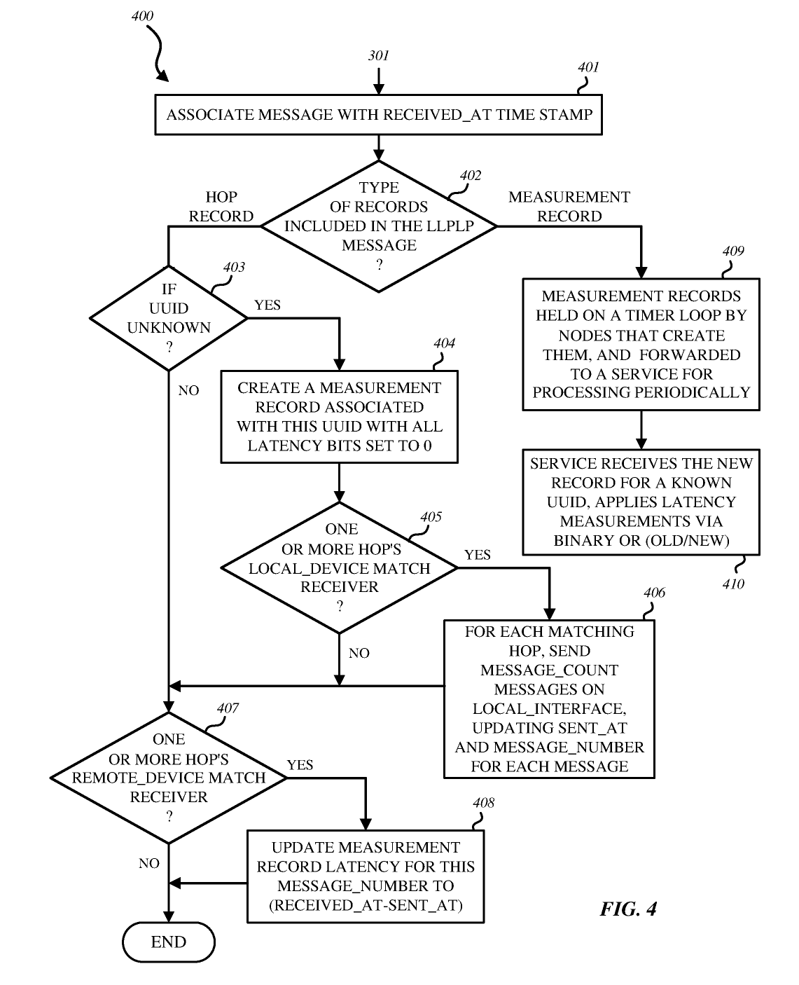

FIG. 4 illustrates a flow diagram of an example method for processing the LLPLP message in Block 302 of the method in FIG. 3 according to one embodiment of the present invention.

At Block 401, the LLPLP message is associated with a RECEIVED_AT timestamp. At Block 402, the type of record is determined. If the record is a hop record, at Block 403, it is further determined whether the UUID is unknown. If the UUID is unknown, at Block 404, a measurement record associated with this UUID is created with all LATENCY bits set to zero. At Block 405, it is determined whether one or more hops LOCAL_DEVICE match receiver. If so, at Block 406, for each matching hop, MESSAGE_COUNT messages on LOCAL_INTERFACE is sent, and SENT_AT and MESSAGE_NUMBER for each message is also updated. At Block 407, it is determined whether one or more hops REMOTE_DEVICE match receiver. If so at Block 408, the measurement record LATENCY for this MESSAGE_NUMBER is updated to (RECEIVED_AT-SENT_AT). If at Block 402, it is determined that the record is a measurement record, at block 409, measurement records will generally be held on a timer loop by nodes that create them, and forwarded to a service for processing periodically. At Block 410, when a service receives measurement records, new records received for a known UUID have their LATENCY measurements applied via binary or (old|new). This allows the protocol to operate asynchronously, treating new information as an update.

### Implementation

The link layer path latency protocol may rely on organizationally specific Link Layer Discovery Protocol (LLDP) type-length-value (TLV) blocks for transport. Organizationally specific LLDP TLV blocks are limited to no more than 507 octets, which has natural implications regarding the total size of the path(s) to be measured by any single message. Additionally the maximum size of a single LLDP protocol data unit (PDU) is limited by the underlying physical media and protocol(s). Therefore, LLPLP enforces that a single measurement may contain up to 12 hops; longer path latencies are calculated by concatenating the results of multiple measurements initiated by an independent LLPLP message.

### Compression and Encoding

HTTP transport can be implemented using application/JavaScript Object Notation (JSON) Multi-Purpose Internet Mail Extensions (MIME) type. For LLDP transport, structures may be represented as binary packed in network byte order.

### Addressing and Transmission

For LLDP transport, all messages may be sent with a source of the sending interface media access control (MAC), a destination of the link-local multicast LLDP address 01:80:c2:00:00:0e and the reserved LLDP ethertype 0x88cc.

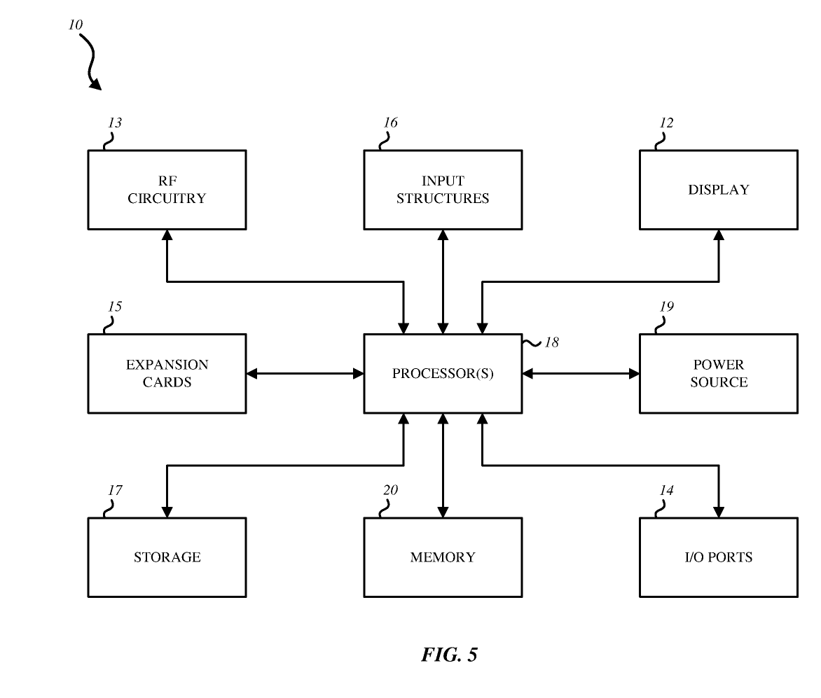

FIG. 5 is a block diagram of exemplary components of an electronic device 10 that may represent an LLPLP actor (e.g., managed node 112A-112N, NMS 106, etc.) in a system (e.g., system 100) implementing LLPLP to monitor per-hop path latency in accordance with aspects of the present disclosure.

The electronic device 10 may be a mobile device such as a mobile telephone communications device or a smartphone. The electronic device 10 may also be a tablet computer, a personal digital media player or a notebook computer. The housing (also referred to as the external housing) encloses a plurality of electronic components of the electronic device 10. For example, the electronic device 10 may include electronic components such as a processor, a data storage containing an operating system and application software for execution by the processor, a display panel, and an audio codec providing audio signals to a speaker driver. It is understood that embodiments of the invention may also be implemented in a non-mobile device such as a compact desktop computer.

In another embodiment, the electronic device 10 includes wireless communications devices having communications circuitry such as radio frequency (RF) transceiver circuitry, antennas, etc. . . . . In this embodiment, the microphone port, the speaker ports may be coupled to the communications circuitry to enable the user to participate in wireless telephone or video calls. A variety of different wireless communications networks and protocols may be supported in the wireless communications devices. These include: a cellular mobile phone network (e.g. a Global System for Mobile communications (GSM) network), including current 2G, 3G and 4G networks and their associated call and data protocols; and an IEEE 802.11 data network (WiFi or Wireless Local Area Network (WLAN)) which may also support wireless voice over internet protocol (VoIP) calling.

In one embodiment, an LLPLP actor (e.g., managed node 112A-112N, NMS 106) includes processing circuitry and storage as shown in electronic device 10 in FIG. 5. The processing circuitry included in device 10 may include a processor 18, such as a microprocessor, a microcontroller, a digital signal processor, or a central processing unit, and other needed integrated circuits such as glue logic. The term “processor” may refer to a device having two or more processing units or elements, e.g. a CPU with multiple processing cores. The processing circuitry may be used to control the operations of device 10 by executing software instructions or code stored in the storage 17. The storage 17 may include one or more different types of storage such as hard disk drive storage, nonvolatile memory 20, and volatile memory 20 such as dynamic random access memory. In some cases, a particular function as described below may be implemented as two or more pieces of software in the storage 17 that are being executed by different hardware units of a processor. The processing circuitry may execute instructions stored in memory that causes the processing circuitry to perform the method of implementing LLPLP to monitor per-hop path latency according to the embodiments as described herein. The processing circuitry may also execute instructions stored in memory that causes the processing circuitry to control the functions of each of the components of the LLPLP actors to cause the components to perform the functions according to the embodiments as described herein.

A general description of suitable electronic devices for performing these functions is provided below with respect to FIG. 5. Specifically, FIG. 5 is a block diagram depicting various components that may be present in electronic devices suitable for use with the present techniques. The electronic device 10 may be in the form of a computer, a handheld portable electronic device, and/or a computing device having a tablet-style form factor. These types of electronic devices, as well as other electronic devices providing comparable functionalities may be used in conjunction with the present techniques.

Keeping the above points in mind, FIG. 5 is a block diagram illustrating components that may be present in one such electronic device 10, and which may allow the device 10 to function in accordance with the techniques discussed herein. The various functional blocks shown in FIG. 5 may include hardware elements (including circuitry), software elements (including computer code stored on a computer-readable medium, such as a hard drive or system memory), or a combination of both hardware and software elements. It should be noted that FIG. 5 is merely one example of a particular implementation and is merely intended to illustrate the types of components that may be present in the electronic device 10. For example, in the illustrated embodiment, these components may include a display 12, input/output (I/O) ports 14, input structures 16, one or more processors 18, memory device(s) 20, non-volatile storage 17, expansion card(s) 15, RF circuitry 13, and power source 19.

In the embodiment of the electronic device 10 in the form of a computer, the embodiment include computers that are generally portable (such as laptop, notebook, tablet, and handheld computers), as well as computers that are generally used in one place (such as conventional desktop computers, workstations, and servers).

The electronic device 10 may also take the form of other types of devices, such as mobile telephones, media players, personal data organizers, handheld game platforms, cameras, and/or combinations of such devices. For instance, the device 10 may be provided in the form of a handheld electronic device that includes various functionalities (such as the ability to take pictures, make telephone calls, access the Internet, communicate via email, record audio and/or video, listen to music, play games, connect to wireless networks, and so forth).

In another embodiment, the electronic device 10 may also be provided in the form of a portable multi-function tablet computing device. In certain embodiments, the tablet computing device may provide the functionality of media player, a web browser, a cellular phone, a gaming platform, a personal data organizer, and so forth.

An embodiment of the invention may be a machine-readable medium having stored thereon instructions which program a processor to perform some or all of the operations described above. A machine-readable medium may include any mechanism for storing or transmitting information in a form readable by a machine (e.g., a computer), such as Compact Disc Read-Only Memory (CD-ROMs), Read-Only Memory (ROMs), Random Access Memory (RAM), and Erasable Programmable Read-Only Memory (EPROM). In other embodiments, some of these operations might be performed by specific hardware components that contain hardwired logic. Those operations might alternatively be performed by any combination of programmable computer components and fixed hardware circuit components. In one embodiment, the machine-readable medium includes instructions stored thereon, which when executed by a processor, causes the processor to perform the methods as described above.

In the description, certain terminology is used to describe features of the invention. For example, in certain situations, the terms “component,” “unit,” “module,” and “logic” are representative of hardware and/or software configured to perform one or more functions. For instance, examples of “hardware” include, but are not limited or restricted to an integrated circuit such as a processor (e.g., a digital signal processor, microprocessor, application specific integrated circuit, a micro-controller, etc.). Of course, the hardware may be alternatively implemented as a finite state machine or even combinatorial logic. An example of “software” includes executable code in the form of an application, an applet, a routine or even a series of instructions. The software may be stored in any type of machine-readable medium.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

What is claimed is:

1. A method comprising:
querying, by an initiating actor of a link layer path latency protocol (LLPLP), a path service to discover a set of paths representing all possible paths between a start node within a private network and an end node within the private network corresponding to a path latency measurement to be made;
decomposing, by the initiating actor, the set of paths into a unique set of a plurality of hops;
creating, by the initiating actor, a first LLPLP message of a first type, including a plurality of hop records corresponding to the plurality of hops in the unique set, wherein each hop record of the plurality of hop records specifies a source node and a corresponding destination node; and
causing, by the initiating actor, (i) the source node specified by each hop record of the plurality of hop records to send one or more LLPLP messages of the first type corresponding to the first LLPLP message to the corresponding destination node and (ii) each corresponding destination node specified by each hop record of the plurality of hop records to calculate and return a latency measurement for the corresponding hop via a second LLPLP message of a second type in response to receiving an LLPLP message of the first type from the source node specified by the hop record as a result of the initiating actor sending the first LLPLP message to the source node specified by a first hop record of the plurality of hop records.

2. A method comprising:
receiving, by a managed node of a plurality of managed nodes in a private network, a first type of link layer path latency protocol (LLPLP) message that requests a path latency measurement to be made between a start node within the private network and an end node within the private network, wherein the first type of LLPLP message includes a plurality of hop records corresponding to a plurality of hops in a unique set of a plurality of hops derived from a set of paths representing all possible paths between the start node and the end node, wherein each hop record of the plurality of hop records specifies a source node and a corresponding destination node; and
for each hop record of the plurality of hop records for which the managed node matches the source node specified by the hop record, sending, by the managed node to the corresponding destination node specified by the hop record, the first type of LLPLP message on a source node interface specified by the hop record, wherein the LLPLP message is revised to include a sent time in a form of a timestamp indicating a time at which the first type of LLPLP message was sent by the managed node;
for each hop record of the plurality of hop records for which the managed node matches the corresponding destination node specified by the hop record setting a latency value within a measurement record associated with the first type of LLPLP message based on a time of receipt of the first type of LLPLP message by the managed node and a time at which the first type of LLPLP message was sent by the source node specified by the hop record; and
periodically sending, by the managed node, a second type of LLPLP message that reports results of the path latency measurement to an initiating actor of the LLPLP.

3. A method of implementing a link layer path latency protocol (LLPLP) to monitor per-hop path latency comprising:
initiating, by an initiating actor of the LLPLP, a path latency measurement between a start node and an end node within a private network, wherein said initiating includes:
querying a path service to discover a set of paths representing all possible paths between the start node and the end node;
decomposing, by the initiating actor, the set of paths into a unique set of a plurality of hops;
creating, by the initiating actor, an LLPLP message, including a plurality of hop records corresponding to the plurality of hops in the unique set, wherein each hop record of the plurality of hop records specifies a source node, a source node interface, a destination node and a destination node interface; and
sending, by the initiating actor, the LLPLP message to the source node specified by a first hop record of the plurality of hop records; and
processing, by a managed node of a plurality of managed nodes in the private network, the LLPLP message, wherein each managed node of the plurality of managed nodes has an agent executing thereon operating as a component actor of the LLPLP and wherein said processing includes:
associating, by the component actor of the managed node, the LLPLP message with receive time in a form of a timestamp indicating a time at which the LLPLP message was received by the managed node;
determining, by the component actor of the managed node, a record type specifying a type of records included within the LLPLP message;
when the record type indicates the type of records are hop records specifying hops to be measured and when the managed node is the source node specified by a hop record of the plurality of hop records, then sending, by the managed node to the destination node specified by the hop record, the LLPLP message on the source node interface specified by the hop record, wherein the LLPLP message is revised to include a sent time in a form of a timestamp indicating a time at which the LLPLP message was sent by the managed node; and
when the record type indicates the type of records are hop records specifying hops to be measured and when the managed node is the destination node specified by the hop record, then updating a latency value within a measurement record associated with the LLPLP message based on the receive time and the sent time.
